(19) United States
(12) Patent Application Publication
(10) Pub. No.: US 2007/0271349 A1
(43) Pub. Date: Nov. 22, 2007

(54) SECURE STORAGE OF DATA IN A NETWORK

(75) Inventors: Gary CLEMO, Bristol (GB); Russell John Haines, Bristol (GB); Timothy Adrian Lewis, Bristol (GB)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/834,460

(22) Filed: Aug. 6, 2007

Related U.S. Application Data
(63) Continuation of application No. 11/095,507, filed on Apr. 1, 2005.

(30) Foreign Application Priority Data
Apr. 1, 2004 (GB) 0407484.5

(51) Int. Cl. G06F 15/16

(52) U.S. Cl. 709/211

(57) ABSTRACT

A method of storing an item of data is described, performed in a general purpose computer in a network, and comprises identifying available storage means in the network, gathering information concerning the availability of data storage capacity in the identified available storage means, fragmenting the item of data in accordance with a fragmentation policy and distributing resultant fragments of data, in accordance with a distribution policy, among the identified available storage means. A computer apparatus is also described, operable in a network for managing and effecting storage of an item of data in a remote storage location in said network, and comprises storage space identification means for identifying network accessible storage means in the network, storage availability information gathering means for gathering information concerning the availability of data storage capacity in the available storage means, fragmentation means for fragmenting the item of data in accordance with a fragmentation policy and distribution means for distributing resultant fragments of data, in accordance with a distribution policy, among the identified available storage means.

This application is a continuation of and claims the benefit of priority under 35 USC §120 from U.S. Ser. No. 11/095,507, filed Apr. 1, 2005 and is based upon and claims the benefit of priority under 35 USC §119 from the United Kingdom Application No. 0407484.5, filed Apr. 1, 2004, the entire contents of which are incorporated herein by reference.

The present invention relates to the storage of data in a secure manner, avoiding security issues relating to the storage of data at a single location.

In many applications of computer-based technology, it is necessary to store data for later use and retrieval for output to a user. Increasingly, computer networks use data which is either of a personal nature or is for another reason confidential, so that the data requires a level of security to be applied to it to prevent it being retrieved or accessed by an unauthorised user.

In many cases, a person gaining unauthorised access to information may find benefit in gaining access to only part of a block of data. For example, in a look-up table setting out the relationship between bank accounts and authorisation passwords, it would not be necessary for unauthorised retrieval of such information to result in retrieval of the entire contents of the table—a single entry in the table could have serious consequences for the holder of the account concerned.

Thus, it is important ensure that the level of security applied to the data is sufficient to prevent comprehensible retrieval of information.

Various security mechanisms have been proposed which, when put in place, can be used to prevent unauthorised access to data. These mechanisms typically involve authentication, to establish the credentials of the person or device accessing the data, and encryption, to prevent data being comprehensible. However, if data is stored in a single location, with the security mechanisms in place, then if the security mechanisms are defeated by an individual or a device seeking access to the data without authority, then the entire data stored at that location will become accessible.

To increase the resilience of the security of data stored within a computer system, it is known to distribute data amongst servers of a network. One application of this technique is the Publius system, which provides security by distributing content amongst servers on the Internet. In this case, the security is intended to prevent unauthorised editing of data, while enhancing the opportunity for retrieval of the data via the Internet. This prevents unauthorised persons disrupting access to the data by in some way rendering inoperable the server on which the data is hosted for retrieval via the Internet.

By on the one hand making it more difficult for an unauthorised or malicious person to make changes to the data hosted on the servers, and on the other hand making the act of disrupting access to the information a more complex process, the ability of an unauthorised third party to disrupt access to the information is substantially limited.

In the Publius system, a publisher computer apparatus encrypts content and causes it to be booted over a subset of web servers available on the Internet. The encryption is carried out using a key which is then split into n shares, such that any k of them can reproduce the original key, but retrieval of k−1 shares is insufficient to determine the key. Each server receives the encrypted content and one of the shares.

At this point, it is impossible to determine, merely by looking at the contents stored on an individual server, the nature of the data stored on the server. The data is entirely encrypted and appears random. In order to browse the content in a comprehensible manner, a browsing apparatus accessing the Internet must retrieve the encrypted Publius content from one of the servers, and k of the shares.

The process of publishing the content in this way causes production of a specific uniform resource locator (URL) that is used to recover the encrypted data and sufficient shares to enable construction of the key. The published content is cryptographically tied to the URL so that any modification to the content, or to the URL, results in the browsing apparatus being unable to find the information, or results in failed verifications.

In addition to this publishing mechanism, the Publius system enables publishers to update or delete their Publius content, while preventing unauthorised parties from doing the same. The overall intention with the Publius technology is to ensure that a document which is published on the Internet is stored in several locations so that if one of those locations is attacked, that the published content is still accessible from other locations.

This system does not aim to nor does it provide an enhancement to the inherent security of data. It is concerned with preventing third parties from compromising the accessibility of data published on the Internet. In essence, the intention with regard to this arrangement is to enhance and maintain access to data, rather than to limit access to confidential data. This is essentially a different technical problem from the present, which is concerned with ensuring that access to data is tightly controlled.

It is an object of the invention to provide a security system for use in a communications network to provide improvements to data storage within the network.

It is a further object of the invention to provide a device, capable of accessing disputed data storage network, such that a user of the device is substantially unaware of the distributed nature of data storage on the network.

It is yet a further object of the invention to provide a method of storing data in a network, such that access to the data is subject to a security regime and such that the compromise of a single storage location will not lead to compromise of the comprehensibility of a stored item of data.

Therefore, according to a first aspect of the invention, a method of storing an item of data, performed in a general purpose computer in a network, comprises the steps of identifying available storage means in said network, gathering information concerning the availability of data storage capacity in said available storage means, fragmenting said item of data in accordance with a fragmentation policy and distributing resultant fragments of data, in accordance with a distribution policy, among said identified available storage means.

The method may comprise a step, preceding said step of fragmenting said data, of determining a fragmentation policy for said data.

The step of determining a fragmentation policy for said data may include determining the type of data to be fragmented and, on the basis of the type of data and the level of comprehensibility of a given fragment of said data, determining the nature and size of fragments into which said step of fragmenting said data should cause said data to be fragmented.

The step of fragmenting said data may comprise identifying segments of said data and identifying non-contiguous pluralities of said segments as a fragment of said data, such that resultant fragments of data comprise interleaved parts of said data.

The method may comprise a step, preceding said step of distributing said data, of determining a distribution policy for said data.

The step of determining a distribution policy for said data may be performed on the basis of the number of fragments of data generated in said step of fragmenting the data and the number of available storage means.

The step of determining a distribution policy for said data may be performed on the basis of the type of data on which the step is performed. In that way, the storage of data fragments in said step of distributing said data can be controlled to take account of the type of data and thus, for example, the extent to which urgent future access to the data is expected.

The step of gathering information concerning the availability of data storage capacity in said available storage means may include gathering information concerning the identified storage means, on the basis of which the distribution policy can then be determined. Said information may include all or any of: information retrieval speed for information stored in said storage means, physical location and/or physical distance from said present general purpose computer, scheduled downtime for said storage means, and tariff information for said storage means charged by a proprietor of said storage means.

According to a second aspect of the invention, a computer apparatus operable in a network for managing and effecting storage of an item of data in a remote storage location in said network, comprises storage space identification means for identifying network accessible storage means in said network, storage availability information gathering means for gathering information concerning the availability of data storage capacity in said available storage means, fragmentation means for fragmenting said item of data in accordance with a fragmentation policy and distribution means for distributing resultant fragments of data, in accordance with a distribution policy, among said identified available storage means.

The computer apparatus may comprise fragmentation policy determining means for determining a fragmentation policy for said data.

The fragmentation policy determining means may include data type determining means for determining the type of data to be fragmented, said data type determining means being operable to determine, on the basis of the type of data and the level of comprehensibility of a given fragment of said data, the nature and size of fragments into which said fragmentation means should cause said data to be fragmented.

The fragmentation means may be operable to identify segments of said data and to allocate, as a fragment of said data, non-contiguous pluralities of said segments, such that resultant fragments of data comprise interleaved parts of said data.

The apparatus may further comprise distribution policy determining means for determining a distribution policy for said data.

The distribution policy determining means may be operable to determine a distribution policy on the basis of the number of fragments of data generated in said step of fragmenting the data and the number of available storage means accessible in the network, in use.

The distribution policy determining means may be operable to determine a distribution policy on the basis of the type of data on which the step is performed. In that way, the storage of data fragments by said distribution means can be controlled to take account of the type of data and thus, for example, the extent to which urgent future access to the data is expected.

The storage availability information gathering means may be operable to gather information concerning the identified storage means in said network in use, on the basis of which the distribution policy can then be determined. Said information may include all or any of: information retrieval speed for information stored in said storage means, physical location and/or physical distance from said present general purpose computer, scheduled downtime for said storage means, and tariff information for said storage means charged by a proprietor of said storage means.

A third aspect of the invention provides a network of computer apparatus each being in communication with at least one other in the network, at least one of said computer apparatus being configured as computer apparatus in accordance with the second aspect of the invention, or configured to perform the method of the first aspect of the invention, and at least one other of the computer apparatus being configured as storage means capable of receiving data from another computer apparatus and storing said data for eventual retrieval.

Whereas apparatus could be provided which was configured to be application specific, i.e. configured as original equipment designed to perform the method of the first aspect of the invention or as apparatus of the second aspect of the invention, a fourth aspect of the invention provides a computer readable program carrier medium, bearing information defining computer executable instructions which, when loaded into a computer, cause that computer either to perform the method according to the first aspect of the invention, or to become configured as apparatus according to the second aspect of the invention.

Similarly, a fifth aspect of the invention provides a computer receivable information carrier signal carrying information defining computer executable instructions which, when loaded into a computer, cause that computer either to perform the method according to the first aspect of the invention, or to become configured as apparatus according to the second aspect of the invention.

Other aspects and advantages of the invention will become apparent from the following description by way of example, of a specific embodiment of the invention, with reference to the accompanying drawings, in which:

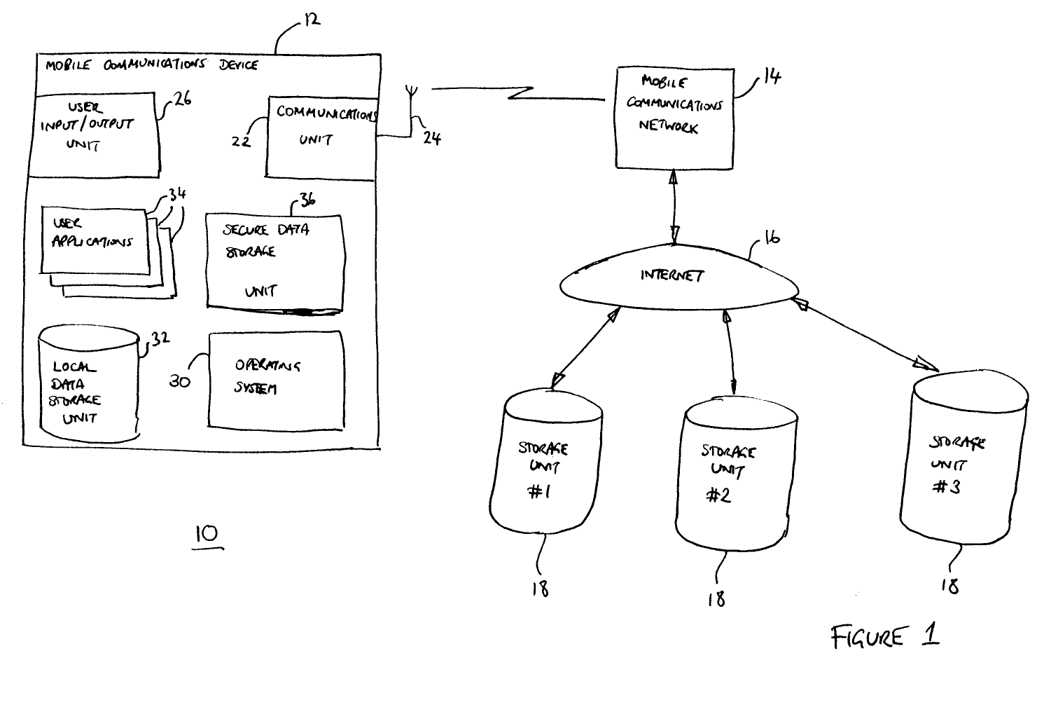

FIG. 1 is a schematic diagram of a communications system implemented by means of the Internet, including a mobile communications device in communication with a mobile communications network;

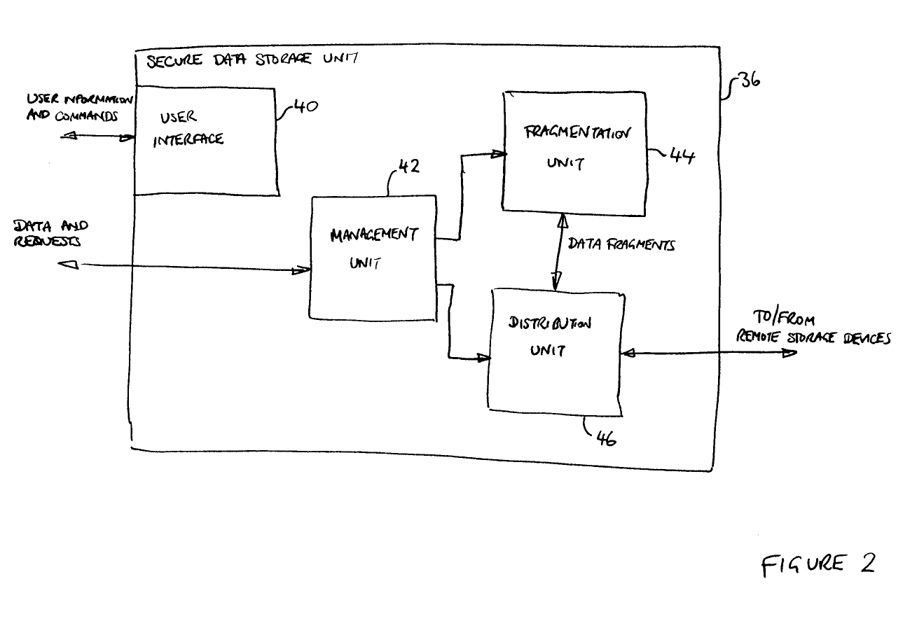

FIG. 2 is a schematic diagram illustrating a secure data storage unit of the mobile communications device illustrated in FIG. 1, in accordance with a specific embodiment of the invention;

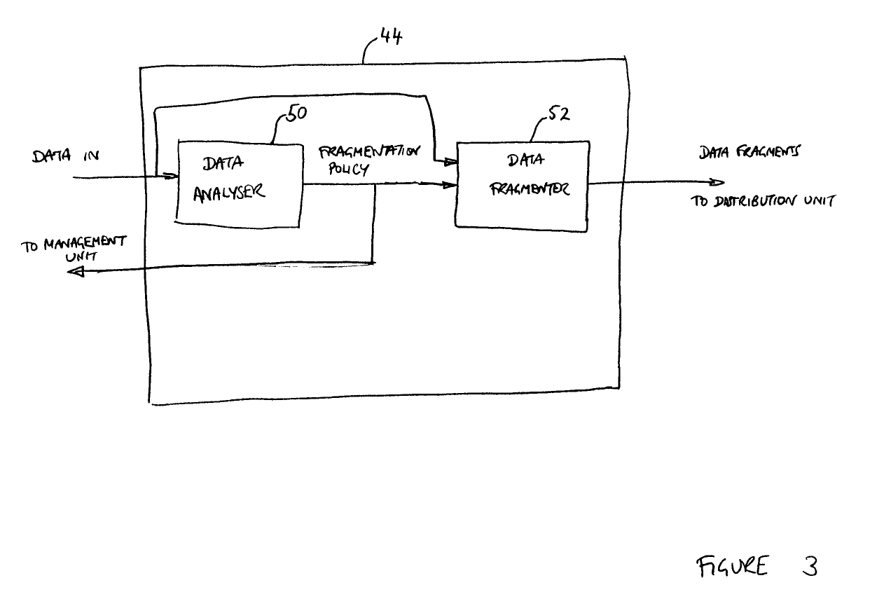

FIG. 3 illustrates a fragmentation unit 44 of the secure data storage unit illustrated in FIG. 2;

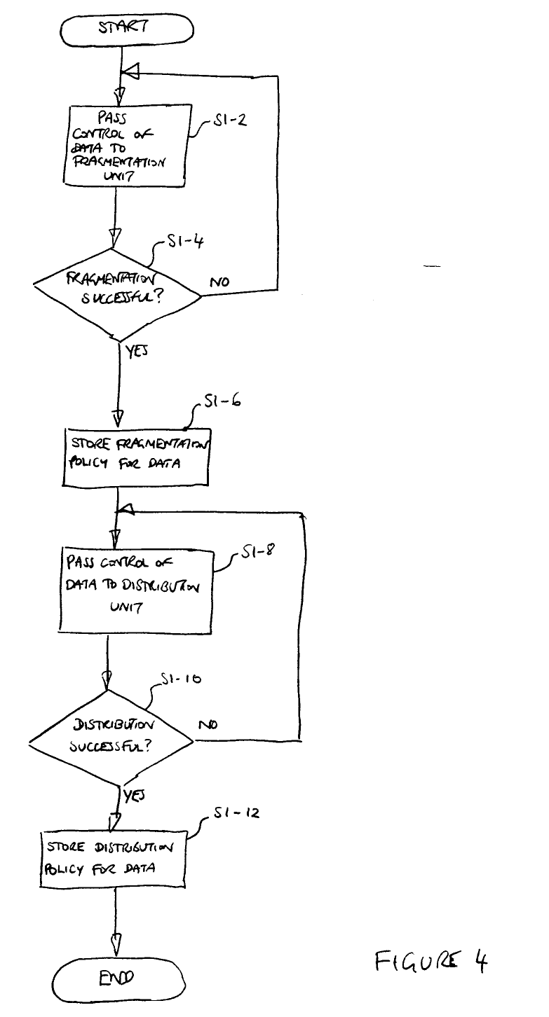

FIG. 4 illustrates a flow diagram setting out a secure data storage management process performed in a management unit 42 of the secure data storage unit illustrated in FIG. 2;

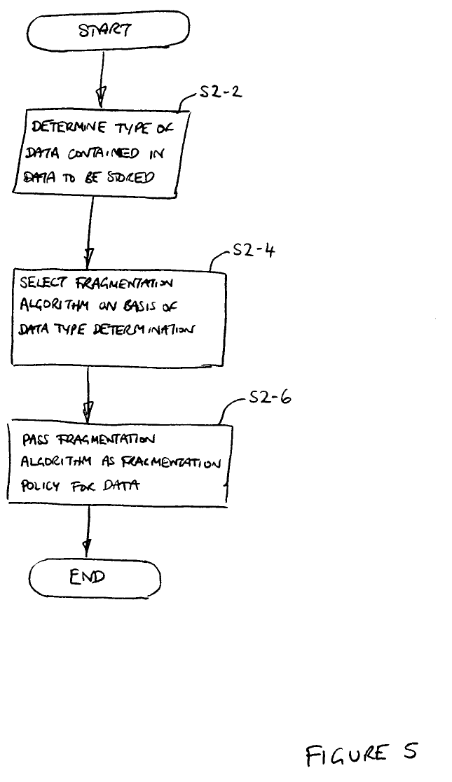

FIG. 5 illustrates a flow diagram setting out a data analysis process performed in the fragmentation unit 44 to determine a fragmentation policy for data to be securely stored in accordance with the specific embodiment of the invention;

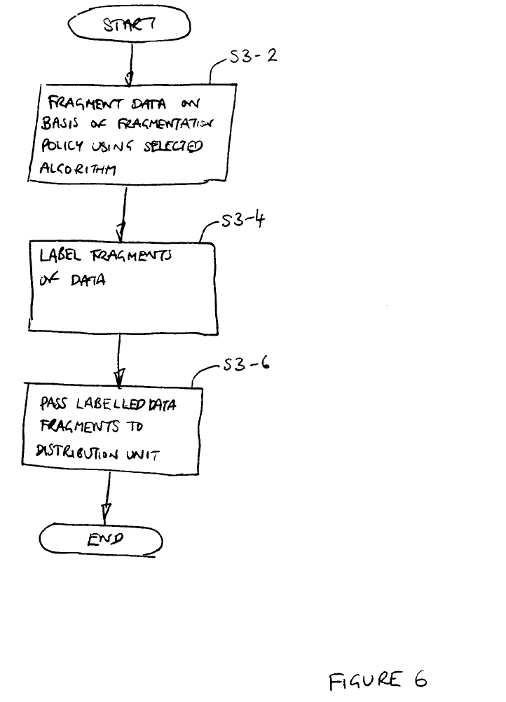

FIG. 6 illustrates a flow diagram setting out a data fragmentation process performed in accordance with the fragmentation policy determined in the process illustrated in FIG. 5;

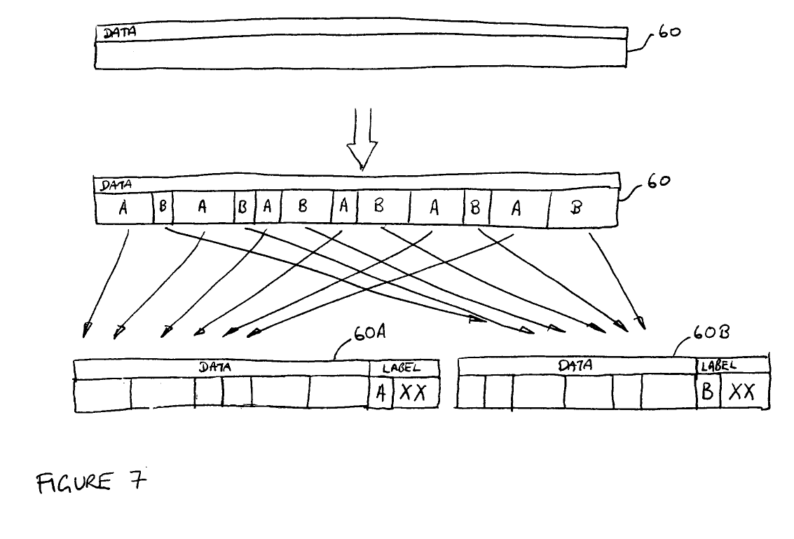

FIG. 7 illustrates schematically the structure of a data packet through the performance of the data analysis process illustrated in FIG. 5 and the data fragmentation process illustrated in FIG. 6;

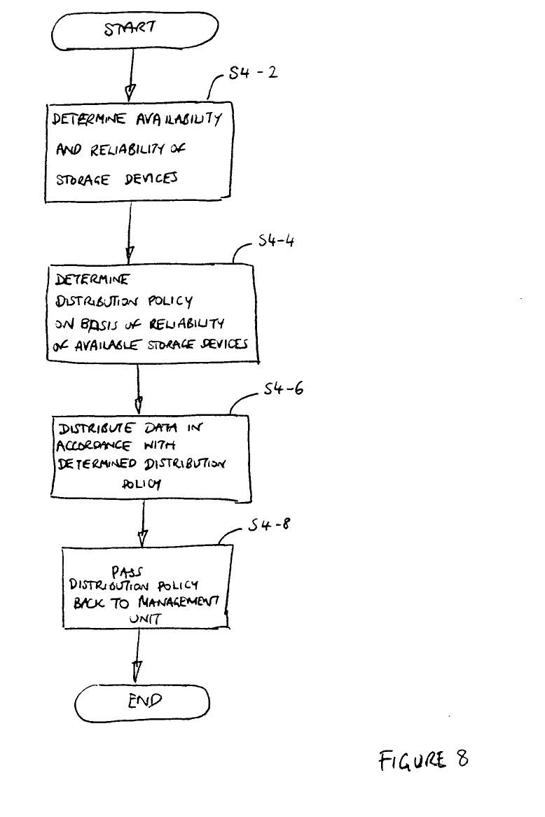

FIG. 8 illustrates a flow diagram setting out a data distribution process performed by a distribution unit of the secure data storage unit illustrated in FIG. 2;

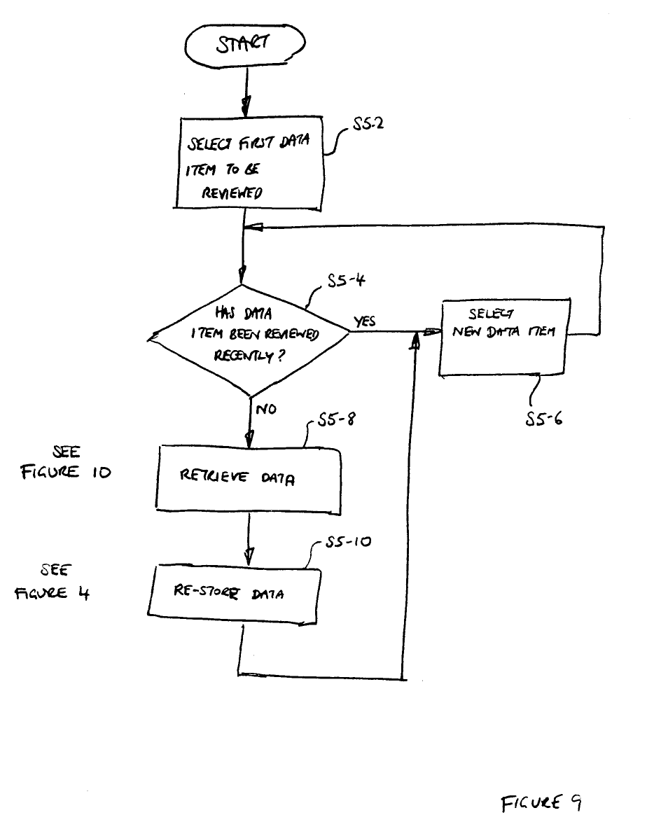

FIG. 9 illustrates a flow diagram setting out a distributed data management process performed by the management unit on storage of data in accordance with the process illustrated in FIG. 4; and

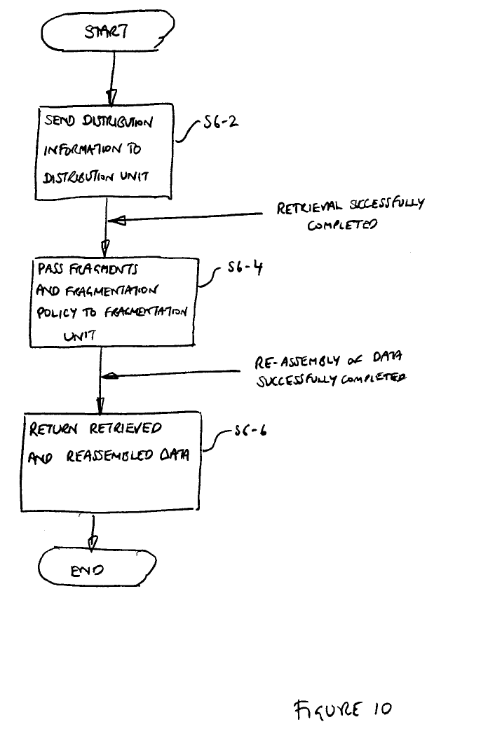

FIG. 10 illustrates a flow diagram setting out a data retrieval process performed on data stored in accordance with the process illustrated in FIG. 4.

As illustrated in FIG. 1, a mobile communications system 10 includes a mobile communications device 12 in data communication with a mobile communications network 14 by means of a wireless connection. In practice, this wireless connection can be implemented by way of any conventional means, such as GPRS or third generation mobile systems (3G).

The wireless data communication established in this way enables the mobile communications device 12 to gain access to the data resources of the Internet 16, which include remotely located storage units 18. While, in the schematic diagram illustrated in FIG. 1, three storage units 18 are illustrated, it will be appreciated that the Internet allows communication with potentially many more storage units.

The structure and function of the mobile communications device 12 will now be described. The structure and function in this embodiment is implemented by means of both hardware and software; for ease of illustration, the mobile communications device 12 as illustrated in FIG. 1 is illustrated schematically, i.e. with no distinction being made between aspects of hardware or software functionality.

The mobile communications device 12 includes a communications unit 22 which establishes communication with other devices by means of an antenna 24, communication being in accordance with established communications protocol, such as using the OSI model. In use, data can be passed to the communications unit 22 by other functional elements of the mobile communications device 12, and the communications unit 22 will handle the transmission and reception of data in a conventional manner.

A user input/output unit 26, which in practice will include a display, user actuable input means such as a keyboard and/or pointing device (mouse, joy stick, etc.) and audio output, enables establishment of a user interface for presentation of information to a user and for monitoring user input actions to be interpreted as data input.

An operating system 30 is executed in the mobile communications device 12 to run underlying operations of the mobile communications device 12 such as management of a local data storage unit 32. The operating system 30 offers functionality to be used by user applications 34, which may include an email handling application, a browser, and multimedia applications.

A secure data storage unit 36 is operable in the mobiles communications device 12 to provide the operating system 30 with a facility to store data securely remotely, i.e. in storage locations such as the storage units 18, as opposed to the local data storage unit 32. The secure data storage unit 36 operates in conjunction with the operating system 30, to process data, such as sent to it by the user applications 34, and to process the data for transmission to storage units 18 via the communications unit 22.

The secure data storage unit 36 is operable to fragment data to the extent required given the level of security to be applied to the data, and to distribute the fragments in a way that trades off security against ease of retrieval and reassembly of the data. The fragmentation strategy is designed to ensure that the individual fragments of data do not reveal the overall nature of the data.

For example, if a piece of comprehensible information can be rendered incomprehensible by merely dividing the information into two fragments, then adequate security may be possible by dividing the information into the two fragments and then storing the two fragments in separate locations. Textual descriptions may fall into this category—by fragmenting the data into two separate files, each file receiving alternate characters of the original text file, the resultant strings of text characters will generally not be comprehensible.

In contrast, if a piece of data comprises a plurality of individual items of data each of which is potentially of value to a malicious recipient, then the data will need to be fragmented to a higher degree to ensure that each individual fragment does not result in a comprehensible piece of information. Credit card details may fall into this category.

Even in the event that fragmentation leads to fragments of data with some residual comprehensibility, the comprehensibility may be so slight that the process of extracting meaning from a maliciously intercepted fragment would be too complex and time consuming to be attractive. By analogy, public key encryption is generally considered to offer a high level of security for most uses. Its operation relies on the fact that in order to deduce the private key from the public key, the public key must be separated into its prime factors. Since the public key is a very large number which has only very large prime factors, this is computationally very difficult and is normally considered impossible in a practical timescale.

However, the fact that a public key is, in theory at least, vulnerable to attack, leaves open the possibility that information encrypted by public key encryption could be accessed without authorisation. This theoretical possibility is accepted by users as an acceptable compromise because the security level is sufficient for most uses and would prevent even highly sophisticated attacks in all but the most extreme cases.

The fragmentation strategy can be influenced by the level of security desired by the user (as input by user input action to the user interface defined by the user input/output unit 26), and the number of storage units 18 illustrated in FIG. 1 available for storage of data fragments. In this way, the overall level of security applied to the data is increased, in comparison with storing the data at a single location, since a significantly greater number of attacks must be successfully made if all of the data is to be recovered. Moreover, it will be difficult to reconstitute data unless distribution and fragmentation strategies are also known to the attacker.

The structure and functionality of the secure data storage unit 36 will now be described with reference to FIG. 2. The secure data storage unit 36 includes a user interface which generates data for the definition of a user interface at the user input/output unit 26, and is operable to receive data corresponding with user input actions. In this way, the user of the mobile communications device 12 is capable of administering and fine tuning settings of the secure data storage unit 36, as required.

A management unit 42 of the secure data storage unit 36 oversees and coordinates the operation of a fragmentation unit 44 and a distribution unit 46. The fragmentation unit 44 is operable to fragment data presented to the secure data storage unit 36 for secure storage. The fragmentation unit 44 is operable to analyse the data and to produce a fragmentation policy, the latter dictating how the data is to be fragmented. The fragmentation unit 44 subsequently fragments the data in accordance with the fragmentation policy. The fragmentation unit 44 is also capable of reassembling fragmented data, on retrieval of data securely stored at remote locations.

The distribution unit 46 is operable to distribute data presented to the system and fragmented by the fragmentation unit 44. The distribution unit 46 maintains a list of storage devices 18 that are available for access via the Internet 16 and which are capable of storage of data fragments. Against each entry for a storage device 18, the list also records one or more characteristics of the storage unit 18, which will be used in the determination of the most suitable storage locations for fragments of data.

The characteristics stored for each available storage unit 18 reflect the fact that the availability of a storage unit 18 is only one of several factors in determining whether the distribution unit 46 is to use that particular storage unit 18. The reliability of the storage unit is also important, i.e. ensuring that, though a storage unit 18 may be available at the time of storage, the future availability of the storage unit should also be taken into account. It would be undesirable for a storage unit to be used that were only available for retrievable data at particular times of the day, when permanent access of the data is required. Further, low reliability of a particular storage device may not rule it out of participation in the secure storage procedure, as the distribution policy may be determined on a basis of using a less reliable storage device, but creating a redundancy by storing a copy of a data fragment stored on the less reliable storage device, at another storage device as well.

Thus, in the present embodiment of the invention, the storage devices to be used advertise their service availability with a number of parameters, such as uptime, physical location (proximity to the mobile communications device 12 is desirable as it may have an impact on data storage and retrieval times) and available capacity. If the storage facility is offered by a storage unit on the basis of costs levied to the user of the mobile communications device, the cost of using the particular storage device may also be advertised.

The distribution unit 46 uses the characteristics of the listed storage units 18 to produce a distribution policy, which dictates how the data fragments are to be distributed amongst the available storage devices 18. The distribution unit 46 then distributes the data fragments amongst the storage devices 18. The distribution unit 46 is also capable of retrieving the data fragments from the storage devices 18, in accordance with the distribution policy for the data concerned.

The manner in which the management unit 42 operates will now be described with reference to FIG. 4. The process illustrated in FIG. 4 commences when data for secure storage is passed to the secure data storage unit, either by the operating system 30, i.e. implicitly and without the user's knowledge, or explicitly by a user application 34 under the control of a user and via user input action received from the user input/output unit. The process commences in step S1-2 when the management unit 42 passes control of the data to be stored to the fragmentation unit 44. In essence, this passage of control can be considered as logical passage of the data itself to the fragmentation unit 44.

In fact, the data may still be stored physically in the local data storage unit 32 during the entire processing operation up to the point of storage of the data remotely, but control of the data is passed to the fragmentation unit 44.

The process then continues by establishing whether fragmentation by the fragmentation unit 44 was successful, in step S1-4. If not, then the process is continued, by returning to step S1-2, and passing control of the data to the fragmentation unit 44 for another attempt at fragmenting the data.

On successful fragmentation of the data by the fragmentation unit 44, the management unit 42 then proceeds in step S1-6 by storing the resultant fragmentation policy data for the data. This fragmentation policy will be used on retrieval of the data, to reassemble the original data from the data fragments produced by the fragmentation unit 44.

Following this, the management unit 42 passes control of the data to the distribution unit 46 in step S1-8. In step S1-10, the management unit 42 establishes whether distribution has been successful. As before, if distribution has not been successful, and thus not resulted in receipt by the management unit 42 of a distribution policy from the distribution unit 46, then step S1-8 is repeated with another attempt to distribute the fragmented data.

On successful distribution of the data fragments, the process in the management unit 42 continues with step S1-12 by storing the resultant distribution policy for the data. This latter policy provides information which, on a request for retrieval of the data, will enable the distribution unit 46 to retrieve the distributed fragments of data, so that they can be reassembled by the fragmentation unit 44 in accordance with the stored fragmentation policy. The process then ends.

The fragmentation unit 44 is illustrated in further detail in FIG. 3, and comprises a data analyser 50 which is operable to receive data to be stored securely and to analyse the data to establish which fragmentation algorithm should be applied and under what conditions. This combination of instructions is known as the fragmentation policy.

This fragmentation policy is passed to a data fragmenter 52, which is operable to receive the data to be stored securely, along with the fragmentation policy, and to fragment the data accordingly. The fragmentation policy is also passed back to the management unit 42, for storage in case the data should be retrieved at a later time. The data fragments resulting from the data fragmenter 52 performing its operation are passed to the distribution unit 46 for distribution in accordance with a distribution policy.

Operation of the data analyser 50 will now be described with reference to FIG. 5. In step S2-2, the type of data contained in the data to be securely stored is determined. Various types of data are possible, such as text files, or video or audio files. The fragmentation policy to be used will depend on the type of data.

For example, text files (all files containing large portions of readable text) should preferably be fragmented to a relatively high degree, with each fragment composed of sections spread throughout the whole document. This will ensure that if, one or two fragments were compromised, the full meaning of the entire document would not become known. In contrast, some video and audio codecs are sufficiently robust to isolate frames being lost and so identifying interleaved fragments will be inappropriate as the file structure will enable recovery of at least part of the content, so a more straightforward split of the file into large contiguous parts would be more appropriate. Other encoded image or video formats require the entire file to be available in order that the file can be played in a multimedia player, so any fragmentation strategy would be appropriate in this case.

Thus, in step S2-4, the fragmentation algorithm appropriate to the type of data determined in the preceding step is selected. Then, in step S2-6, the fragmentation algorithm is designated as the fragmentation policy for the data, for further use. The procedure then ends.

FIG. 6 illustrates the process of fragmentation performed in the data fragmenter 52 of the fragmentation unit 44, on receipt of a fragmentation policy and data to be fragmented. A specific example of use of the process of FIG. 6 is illustrated in FIG. 7, with a packet of data 60 being passed through the processing steps. The example is based on an item of data which consists of a text file, which was established in the process of FIG. 5 as performed by the data analyser 50, and thus a fragmentation policy will consist of a high degree of fragmentation of the data into sections, each fragment being composed of sections spread throughout the whole text file.

Thus, in step S3-2, the data 60 is fragmented on the basis of the fragmentation policy, using the selected algorithms. As shown in FIG. 7, the data is fragmented by identifying different sections of the data as destined for a fragment A or B. Then, the sections are assembled into fragments.

Then in step S3-4, the fragments are labelled, as shown in FIG. 7, with each fragment being labelled with a unique fragment identifier (A or B in this example) and a data identifier (XX in this example). These identifiers will allow tracing of the data at a later time when retrieval of the data is required.

In step S3-6, the labelled data fragments are passed to the distribution unit 46 for distribution of the fragments.

Operation of the distribution unit 46 will now be described with reference to FIG. 8, which illustrates a process by which the distribution unit 46 can distribute fragments of data. The extent of distribution possible at any time is dependent on the number of available storage devices 18, on reliability of the available storage units 18, on any possible periods of unavailability (downtime) of the available storage units 18, of any costs levied by the proprietors of the available storage units 18 for use by the user of the mobile communications device 12, and the physical proximity of the storage devices 18 (promoting fast access speeds and reliable connections).

Therefore, in step S4-2 of the process illustrated in FIG. 8, the availability and reliability of the storage devices 18 are determined. This is carried out on the basis of information made available by the available storage devices. This information may be made available by broadcast, by serving information via the Internet, or by any other conventional means.

Then, in step S4-4, a distribution policy is determined, on the basis of reliability of available storage devices 18 and on the basis of the stored characteristics as described above. In this example, all characteristics are used, in order to take account of all available information. In step S4-6, the data fragments produced by the fragmentation unit 44 are distributed in accordance with the determined distribution policy, by the distribution unit 46. Finally, in step S4-8, the established distribution policy is passed to the management unit 42 for storage, so that, when the data to be securely stored is to be retrieved, the distribution policy can be passed back to the distribution unit 46 to enable access.

It will be appreciated that, in practice, a designer will have considerable design freedom with regard to which aspects of the function should be delivered by operation of application specific hardware and which should be delivered by the execution of software on a computer.

While it will be appreciated that various different fragmentation algorithms could be used, the process described in FIG. 5 provides a most effective way of determining the appropriate fragmentation algorithm for a particular data.

There do not necessarily need to be as many storage devices as fragments to be stored, to enable the secure storage of data in accordance with the invention. It will be appreciated that, by storing several apparently disconnected fragments of the same item of data at a single storage device 18, and other such fragments at other storage devices 18, the effect of distribution can be at least partly maintained, in the event that the number of available storage devices 18 is lower than the number of fragments to be stored.

It will be appreciated that, in the determination of a distribution policy, the distribution unit 46 may take account of any or all of the stored characteristics, or may simply determine a distribution policy on the basis of available storage units 18.

It should be recognised that the process of fragmenting data may have an inherent processing overhead, as may have the process of reassembling fragmented data. Thus, overuse of fragmentation could have a negative impact on system performance, as it would then place unnecessary processing demand on the system, both in fragmenting the data and in reassembling data on retrieval. Consideration should be made of the processing requirement associated with fragmentation and distribution of data, in accordance with an embodiment of the invention.

Further, the process of distributing fragmented data can increase data retrieval rates, particularly if use is made of relatively remote server locations or locations only accessible via a connection with a low data retrieval rate. Determination of a distribution policy should, in a preferred embodiment of the invention, take account of this factor.

The utilisation of remotely stored data enables the storage of more information than could be stored on the mobile communications device itself. Over time, however, the accumulation of fragmentation and distribution policy data could itself become unwieldy and an embodiment of the invention could include the facility for remote and secure storage of this information as well. Preferably, the fragmentation and distribution data relating to frequently accessed data is stored separately (and possibly locally) from less frequently accessed data, which can be stored without rapid retrieval being a primary consideration.

The distribution and fragmentation algorithms are periodically executed on fragmented and distributed data to ensure that distribution of data continues to be at a suitable level to maintain security of the data. Further, this allows any changes in the characteristics of the storage devices 18 (such as increased storage tariffs or altered periods of unavailability) to be taken into account.

FIG. 9 illustrates the manner by which the management unit 42 periodically checks the effectiveness of fragmentation and distribution. In step S5-2, the management unit 42 selects a data item, previously stored remotely using the fragmentation unit 44 and the distribution unit 46, to be checked. In step S5-4, the data item is checked to establish when it was last checked, or last stored. If this took place relatively recently (a criterion to be determined in the context of the operating performance of the mobile communications unit itself), then in step S5-6 the management unit 42 selects the next data unit for consideration and repeats the enquiry in step S5-4 until a data item is found that was stored a sufficient time in the past to justify retrieval and re-storage.

In step S5-8 the procedure continues and the management unit 42 directs the retrieval of the selected data item, using the fragmentation unit 44 and the distribution unit 46. The process by which this is achieved is illustrated in FIG. 10 and described in further detail below.

As noted previously, the processes by which the fragmentation unit 44 fragments data and the distribution unit 46 distributes fragments of data, are reversible as they follow a set of reversible rules defined in the fragmentation and distribution policies respectively.

Following successful retrieval of the data in step S5-8, then in step S5-10 the data is re-stored, making use of the process in the management unit 42 illustrated in FIG. 4. The process then continues by returning to step S5-6 for further consideration of data items previously stored by the secure data storage unit 42.

A process of retrieval of data, such as for re-storage as shown in the process illustrated in FIG. 9, or because the data in question is required for use in another process of the mobile communications device 12, is illustrated in FIG. 10. In step S6-2, the management unit 42 sends distribution information (i.e. the distribution policy and any other identification information) to the distribution unit 46, with an instruction that the data identified by the distribution information is for retrieval. The distribution unit 46 is then configured to retrieve the information, and to send a signal back to the management unit that the information has been retrieved. On retrieval, the distribution unit 46 transfers operational control over the retrieved data fragments to the management unit 42.

Following retrieval of the information, and corresponding receipt of a message to that effect by the management unit 42, the management unit 42 passes operational control of the data fragments to the fragmentation unit 44, together with the corresponding fragmentation policy and an instruction that the fragmentation unit 44 should reassemble the data item from the fragments. The fragmentation unit 44 applies the same procedure as it used to fragment the data, but in reverse. On completion of reassembly of the data, the fragmentation unit 44 sends a message back to the management unit 42, transferring operational control over the reassembled data back to the management unit 42.

Then, on completion of reassembly of the fragments, and receipt of the message from the fragmentation unit 44, the management unit 42 outputs the reassembled fragment, either as requested by another process executed on the mobile communications device 10, or as the data to be re-stored in the process illustrated in FIG. 9.

The present invention, as illustrated by the specific embodiments described above presents significant advantage to the operation of mobile communications device because a typical mobile communications device has limitations on local storage capacity. Whereas, with a relatively static device, very large amounts of memory can be provided, a mobile communications device is to some extent constrained by its physical size. Therefore, memory resource needs to be managed to avoid over-use and consequent device failure.

Thus, the motivation for providing remote storage for a mobile communications device is high. However, this can lead to inherent insecurity of the remotely stored data, and the present invention resolves this issue by fragmenting and distributing the data so that the mobile communications device may retrieve the data as requires by a user.

While the invention has been described, by way of example, in the context of a mobile communications device wherein the invention is embodied in pre-determined functionality of the device either in terms of hardware or software, or in terms of a combination of the two, it will be appreciated that the invention could be provided on a general purpose computer or programmable communications device, configured by software loaded thereon, the software comprising one or more programs for a computer, the or each program being capable of being loaded into the computer from a computer program product. Examples of such a computer program product include a computer readable carrier medium (such as an optical or magnetic disk) or an electronic storage medium such as flash memory, or a signal bearing data receivable in a computer and when loaded into the computer constructing a file containing corresponding computer executable instructions to establish the computer program product in the computer.

Further, the configuration of a general purpose computing device could include introducing, by any available method, a software or hardware plug-in to existing functionality to reconfigure the computing device to operate in accordance with a specific embodiment of the invention.

1. A method of storing an item of data, performed in a general purpose computer in a network, comprising:
identifying available storage means in said network,
gathering information concerning the availability of data storage capacity in said available storage means,
fragmenting said item of data in accordance with a fragmentation policy and
distributing resultant fragments of data, in accordance with a distribution policy, among said identified available storage means.

2. A method in accordance with claim 1 and comprising, preceding said step of fragmenting said data, determining a fragmentation policy for said data.

3. A method in accordance with claim 2 wherein said step of determining a fragmentation policy for said data includes determining the type of data to be fragmented and, on the basis of the type of data and the level of comprehensibility of a given fragment of said data, determining the nature and size of fragments into which said step of fragmenting said data should cause said data to be fragmented.

4. A method in accordance with claim 1 wherein the step of fragmenting said data comprises identifying segments of said data and identifying non-contiguous pluralities of said segments as a fragment of said data, such that resultant fragments of data comprise interleaved parts of said data.

5. A method in accordance with claim 1 and comprising, preceding said step of distributing said data, determining a distribution policy for said data.

6. A method in accordance with claim 5 wherein the step of determining a distribution policy for said data is performed on the basis of the number of fragments of data generated in said step of fragmenting the data and the number of available storage means.

7. A method in accordance with claim 5 wherein the step of determining a distribution policy for said data is performed on the basis of the type of data on which the step is performed.

8. A method in accordance with claim 5 wherein the step of gathering information concerning the availability of data storage capacity in said available storage means includes gathering information concerning the identified storage means, on the basis of which the distribution policy can then be determined.

9. A method in accordance with claim 8 wherein said information includes all or any of: information retrieval speed for information stored in said storage means, physical location and/or physical distance from said present general purpose computer, scheduled downtime for said storage means, and tariff information for said storage means charged by a proprietor of said storage means.

10. Computer apparatus operable in a network for managing and effecting storage of an item of data in a remote storage location in said network, comprising storage space identification means for identifying network accessible storage means in said network, storage availability information gathering means for gathering information concerning the availability of data storage capacity in said available storage means, fragmentation means for fragmenting said item of data in accordance with a fragmentation policy and distribution means for distributing resultant fragments of data, in accordance with a distribution policy, among said identified available storage means.

11. Computer apparatus in accordance with claim 10 and comprising fragmentation policy determining means for determining a fragmentation policy for said data.

12. Computer apparatus in accordance with claim 11 wherein the fragmentation policy determining means includes data type determining means for determining the type of data to be fragmented, said data type determining means being operable to determine, on the basis of the type of data and the level of comprehensibility of a given fragment of said data, the nature and size of fragments into which said fragmentation means should cause said data to be fragmented.

13. Computer apparatus in accordance with claim 10, wherein the fragmentation means is operable to identify segments of said data and to allocate, as a fragment of said data, non-contiguous pluralities of said segments, such that resultant fragments of data comprise interleaved parts of said data.

14. Computer apparatus in accordance with claim 10, further comprising distribution policy determining means for determining a distribution policy for said data.

15. Computer apparatus in accordance with claim 14 wherein the distribution policy determining means is operable to determine a distribution policy on the basis of the number of fragments of data generated in said step of fragmenting the data and the number of available storage means accessible in the network, in use.

16. Computer apparatus in accordance with claim 14 wherein the distribution policy determining means is operable to determine a distribution policy on the basis of the type of data on which the step is performed.

17. Computer apparatus in accordance with claim 14 wherein the storage availability information gathering means is operable to gather information concerning the identified storage means in said network in use, on the basis of which the distribution policy can then be determined.

18. Computer apparatus in accordance with claim 17 wherein said information gathered by said storage availability information gathering means includes all or any of: information retrieval speed for information stored in said storage means, physical location and/or physical distance from said present general purpose computer, scheduled downtime for said storage means, and tariff information for said storage means charged by a proprietor of said storage means.

19. A network of computer apparatus each being in communication with at least one other in the network, at least one of said computer apparatus being configured to perform the method of claim 1, and at least one other of the computer apparatus being configured as storage means capable of receiving data from another computer apparatus and storing said data for eventual retrieval.

20. A network of computer apparatus each being in communication with at least one other in the network, at least one of said computer apparatus being configured as computer apparatus in accordance with claim 10, and at least one other of the computer apparatus being configured as storage means capable of receiving data from another computer apparatus and storing said data for eventual retrieval.

21. A computer readable program carrier medium, bearing information defining computer executable instructions which, when loaded into a computer, cause that computer to perform a method in accordance with claim 1.

22. A computer readable program carrier medium, bearing information defining computer executable instructions which, when loaded into a computer, cause that computer to become configured as apparatus in accordance with claim 10.

23. A computer receivable information carrier signal carrying information defining computer executable instructions which, when loaded into a computer, cause that computer either to perform a method in accordance with claim 1.

24. A computer receivable information carrier signal carrying information defining computer executable instructions which, when loaded into a computer, cause that computer either to perform the method according to the first aspect of the invention, or to become configured as apparatus in accordance with claim 10.
